(19) United States
(12) Patent Application Publication
(10) Pub. No.: US 2021/0307258 A1
(43) Pub. Date: Oct. 7, 2021

(54) CULTIVAR GROWING SYSTEM AND METHOD

(71) Applicant: Cadence Agricultural Systems Inc., Oakville (CA)

(72) Inventors: James Clark, Williams (CA); Steve Martin, Limehouse (CA)

(21) Appl. No.: 17/264,968

(22) PCT Filed: Aug. 1, 2019
(86) PCT No.: PCT/CA2019/051051

§ 371 Date: Feb. 1, 2021

(30) Foreign Application Priority Data
Aug. 2, 2018 (CA) 3,013,146

(51) Int. Cl. A01G 9/24; A01G 7/04; A01G 9/14; A01G 9/18; A01G 9/02; G05B 13/02

(52) U.S. Cl. CPC A01G 9/249; A01G 7/045; A01G 9/247; A01G 9/246; G05B 13/024; A01G 9/18; A01G 9/027; A01G 9/023; A01G 9/143

(57) ABSTRACT

A cultivar growing system is disclosed that may comprise a plurality of chambers. Each chamber comprises a floor, walls and a ceiling. The chambers also support a plurality of cultivars. The chambers also include sensors that monitor light, temperature, humidity, leaf temperature, vapor pressure deficit, carbon dioxide, plus grow medium temperature, oxygen, pH level, total dissolved solids, and electrical conductivity, and nutrients in the chamber and lighting elements that supply light from the direction of the ceiling of the chamber. The chamber also includes an air supply that supplies air from the direction of the floor of the chamber and a nutrient supply that provides nutrients and water to the cultivars. The chamber may also include one or more control systems for controlling the lighting elements, air supply and nutrient supply, wherein the one or more control systems incorporates information from the sensors and a predetermined growth recipe.

### CROSS-REFERENCE TO RELATED APPLICATION

This application is a national stage application, filed under 35 U.S.C. § 371, of International Patent Application No. PCT/CA2019/051051, filed on Aug. 1, 2019, which claims priority to Canadian Patent Application No. 3,013,146, filed on Aug. 2, 2018, both of which are incorporated by reference herein in their entireties. In the event of inconsistent usages between this document and those documents so incorporated by reference, the usage in the incorporated references should be considered supplementary to that of this document; for irreconcilable inconsistencies, the usage in this document controls.

### TECHNICAL FIELD

The present disclosure relates to a system and method for growing cultivar using an array of enclosed chambers.

### TECHNICAL BACKGROUND

Cultivars grown for industrial usage may be grown indoors. Indoor growing of plants usually involves providing nutrients and light to the plant to encourage plant growth.

In existing systems, plants may be grown from seeds or clones, through to harvest. Even with indoor growing, significant amount of manual labour may be required to monitor and harvest the crop.

It is therefore desirable for a more efficient indoor growing system to be provided.

### BRIEF DESCRIPTION OF THE DRAWINGS

In drawings which illustrate by way of example only embodiments of the present disclosure, in which like reference numerals describe similar items throughout the various figures,

FIG. 1 is a cut-away perspective view of a chamber.

FIG. 2 is a perspective view of an array of chambers with one chamber highlighted.

FIG. 3 is a perspective view of multiple arrays of chambers.

FIG. 4 is a cross-section schematic of a chamber.

### DETAILED DESCRIPTION

The system and method described generally relate to growing cultivars in an array of chambers. The cultivars may be any plant, particular a plant grown for commercial or industrial purposes. As an example, the cultivars may be lettuce or cannabis.

Each chamber, as will be described in more detail below, is generally self-contained and allows plant growth properties to be monitored and controlled independently, or mostly independently, of the properties of other chambers.

Preferably, a series or array of chambers are used as part of a growing system. Separate chambers may contain cultivars at different stages of growth. Separate chambers may be used for each day of the growth cycle for the cultivar. If a cultivar grows from seed or clone to a harvestable state in X days, then X chambers may be used. In this way, each day, a single chamber may be planted or clones established. In addition, each day, a single chamber may be harvested.

Unlikely systems where an entire harvest matures and is ready for harvest substantially simultaneously, in the present system, only a portion of the crop is ready for harvest at any one time. This reduces the amount of processing capabilities, whether automated or manual, required to harvest the crop. For example, manual labour to harvest a single chamber per day is all that may be required to harvest the crop. Similar benefits may be found for other steps of the growth process, such as with planting, cloning, or trimming.

Although the described as having one chamber for each day of the growth cycle, variants of the system may be used where there are multiple chambers, say two or three, for each day of the growth cycle. Alternatively, there may be fewer chambers than days in the growth cycle, such as with one chamber for every two days of the cycle. In this alternative, a chamber may not be harvested every day, such as by having a chamber harvested every second day.

Each chamber may be generally cubic, or a rectangular prism. Chambers 10 may contain multiple cultivars 15, such as arranged in a grid pattern in the chamber, permitting each cultivar to grow within the chamber. The number of cultivars in a chamber may depend on the size of the cultivars, particularly at harvest, the capacity of the chamber to provide light and nutrients and remove waste, and the size of the chamber. In an embodiment with cannabis plants, the plants may be placed on six-inch centres within the chamber. In an embodiment, each chamber may be four feet by four feet by four feet.

### Chamber

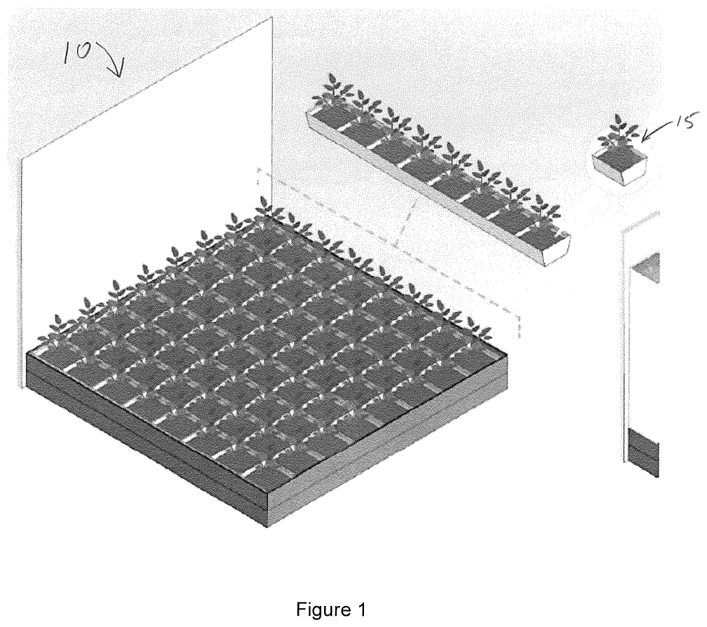

With reference to FIG. 1, a chamber 10 may contain sixty-four cultivar 15, such as arranged eight by eight plants, although more or less cultivars may be in a chamber. The cultivars may be arranged on a removable skid 12 within the chamber so that the plants can be easily removed from the chamber for harvest. In embodiments, the skid 12 may be manipulated by automatic means or manually using a forklift, lift truck or conveyor. The skid 12 may rest on the floor 14 of the chamber 10, such as on wheels or slid plates, or may be supported on brackets attached to the walls 50 or floor 14.

The chamber may have one or more opening walls, or doors, so that a skid may be removed from the side of the chamber. The opening of a wall may also facilitate access to the chamber for cleaning, calibration or repairs.

A configuration skid or calibration tray may be used to test or configure a chamber. A configuration skid may be placed into a chamber in place of cultivar. Sensors on the configuration skid may detect light, CO₂, O₂, temperature, humidity, leaf temperature, vapor pressure deficit, soil or other grow medium temperature, grow medium oxygen, water and/or grow medium pH level, total dissolved solids (TDS), and electrical conductivity, and other properties of the chamber, such as during a test recipe of the chamber to check that the sensors of the chamber are detecting such properties accurately and the control system is operating the chamber within desired parameters. Sensor readings from the configuration skid may be monitored and used to adjust the chamber, or may result in the chamber being replaced or repaired.

Chambers 10 may be arranged next to each other, including stacked on top of each other. The chambers may be interconnected to provide structural engagement between the chambers to that a group of chambers can be moved, or handled as a group, and so the chambers do not fall over. The chambers may also be connected together to shared resources such as electrical power, sources of nutrients, water, air, carbon dioxide, oxygen and to waste outputs, such as exhaust air and nutrient depleted water. The chamber may also have an electrical and control connection for powering and communicating with the sensors, lights, and chamber control systems. The control systems may communicate with a central control system, or other control systems, over a communication network, such as wireless (such as WIFI or Bluetooth) or wired (such as Ethernet).

The chambers may include a consistent interface for the supplies of material and control signals so that each chamber can be removed and replaced within the larger group of chambers.

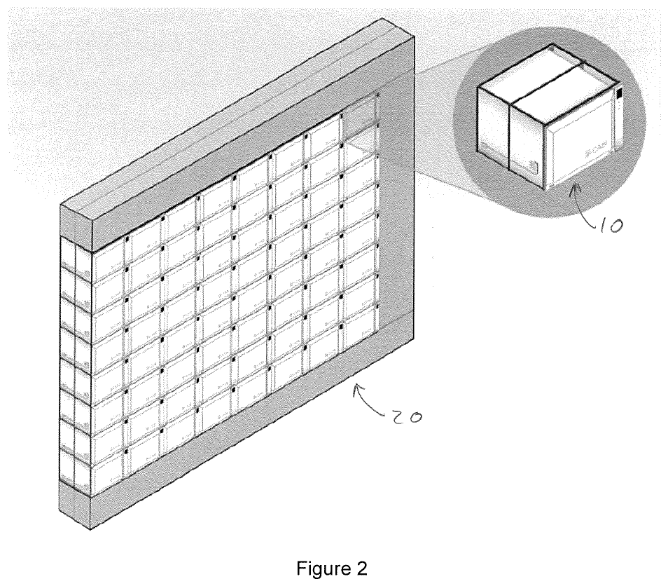

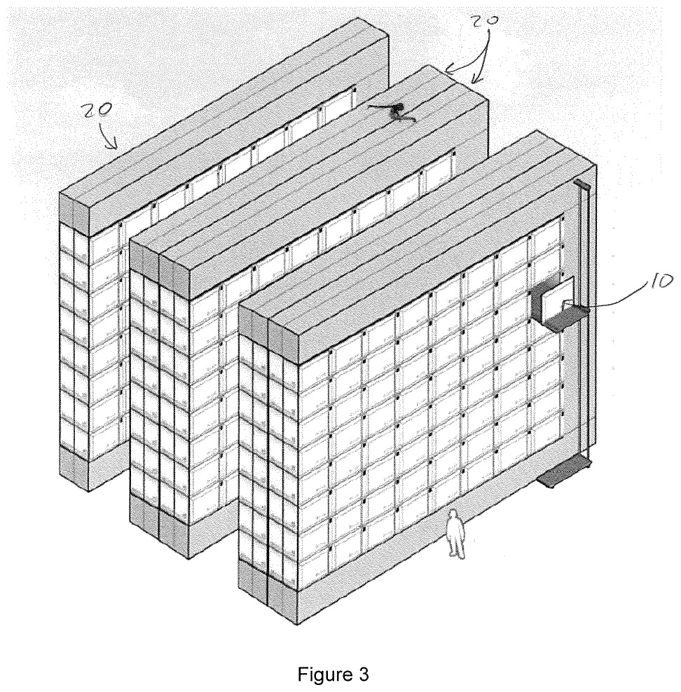

With reference to FIG. 2, chambers 10 may be arranged in groups of eight to form a row of chambers and eight rows may form an array 20 of chambers. Larger or smaller rows and arrays may be formed. The size may depend on the physical space available for the system, the growth characteristics of the cultivars and the needs of the owner. With reference to FIG. 3, multiple arrays 15 may be used. Having arrays of 64 chambers may be desirable, particularly for cannabis, where the growth cycle from vegetative stage to harvest is on average 64 days. For other cultivars, fewer chambers may be used in an array. For example, with lettuce, which has an average of 35 days, 35 chambers may be used so that one chamber is ready for harvest each day.

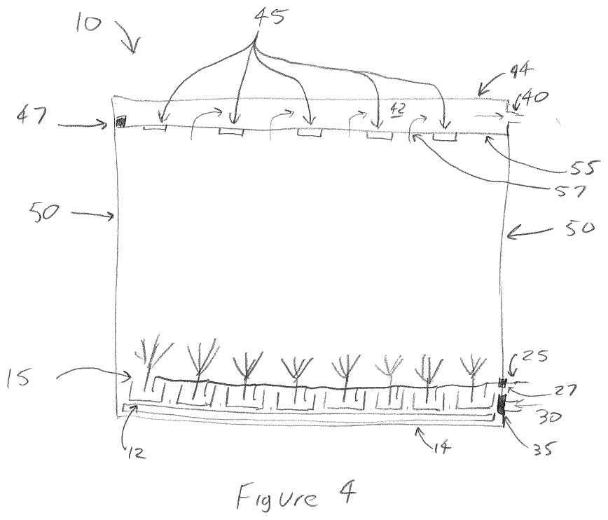

With reference to FIG. 4, a chamber 10 may contain multiple cultivars 15. The cultivars 15 may be arranged in pots, holders or other means for supporting the plants within the chamber. The roots may be supplied with nutrients such as by being immersed in soil or other grow medium or a nutrient solution, such as through hydroponic means.

### Nutrient Supply

A nutrient supply 25 may supply nutrient solution to the cultivars, such as by individually applying the solution to each plant. Alternatively, the cultivars may share a common reservoir, and nutrient solution provided to the common reservoir. Valves may be used to control the flow of nutrient and water to the cultivars, either collectively or individually. A nutrients monitoring and control system 27 at the chamber may using one or more sensors to monitor the level of nutrients, solution and water being applied to the cultivars. The nutrients monitoring and control system 27 may adjust the concentration of nutrients being added to the solution, adjust the amount of solution being added to water, or make other adjustments to control the amount of and type of nutrients being received by the cultivars, such as by operating one or more values. The nutrient supply 25 may comprise separate supplies for water, one or more nutrients and/or a premixed nutrient solution.

One or more common supplies of nutrients may be used to supply a plurality of chambers. Values, such as solenoid-controlled values, may be used to control the supply of nutrient to a particular chamber. The nutrients from the one or more sources may be supplied directly to the cultivars, or mixed with water at the chamber or for a plurality of chambers. There may be two supplies of nutrients, one appropriate for a vegetative step of the cultivar and a second appropriate for a bloom state of the cultivar. With these two supplies of nutrients, the nutrients monitoring and control system 27 may select from one or both of the two supplies to be applied to the cultivars depending on the growth stage.

The nutrients monitoring and control system 27 may also monitor the grow medium moisture, grow medium temperature, pH level, oxygen level, and Electrical Conductivity (EC) in the chamber, such as using sensors in one or more of the pots of the cultivar. For hydroponic grow chambers, sensors may monitor the operation of the hydroponic systems.

### Air Supply

The chamber may have an air input 30 for receiving input air. The air may be preconditioned, such as being heated or cooled by an HVAC system, prior to introducing the air into the chamber. Alternatively, the chamber may contain a processing unit for conditioning the incoming air to the appropriate temperature and quality. For example, levels of carbon dioxide and oxygen may be adjusted so that the air entering the chamber has carbon dioxide and oxygen at the appropriate level. Preferably, the chamber can monitor and control the temperature in the range of 15 to 35 degrees Celsius, humidity in the range of the 30 to 70 percent relative humidity, and CO₂ in the range from 350 ppm to 4000 ppm. Depending on the desired cultivars to be grown in the chamber, a reduced range may be acceptable.

If the air conditioning takes place at the chamber, then the chamber may receive oxygen and carbon dioxide so an air monitoring and control unit 35 may add oxygen and carbon dioxide as needed. The air monitoring and control unit may include sensors for detecting the levels of oxygen and carbon dioxide inside the chamber, as well as the levels in any incoming air. The air monitoring and control unit may compare the current values for the concentration of oxygen and carbon dioxide to determine what adjustments are needed to the incoming air to maintain or adjust the carbon dioxide and oxygen levels within the chamber to levels determined by the system. The air monitoring and control unit may similarly monitor and adjust the level of humidity in the incoming air.

The air may be conditioned using one or more of heating or cooling of the air, such as using conditioning coils, and/or compressors inside or outside the chamber. Dehumidifiers may be used to reduce the humidity of the incoming air prior to being introduced into the chamber. Common air conditioning and dehumidifiers may be used for a plurality of chambers to improve efficiency and reduce the cost. For example, conditioning units, may be shared between a plurality of chambers such as 8 chambers. For larger systems, multiple conditioning units may be used. As discussed above, the conditioning units may monitor and control one or more of the temperatures, humidity, oxygen concentrations and carbon dioxide concentrations of the air being introduced into one or more chambers.

The air introduced into the chamber, including as modified by the air monitoring and control unit 35 may be applied under pressure, such as by a fan. The air may pass into the chamber below the leaves of the cultivar so that the air is forced to pass upward through the chamber pass the leaves. Preferably, the air is disbursed evenly through the chamber through one or more vents, or a diffuser below the plants.

The entire base of the chamber may be covered with a diffuser panel or set of diffuser panels creating a plenum, or enclosure, containing gas at a higher pressure than atmospheric pressure, under the diffuser panel or diffuser panels. Pressurized, conditioned air may be supplied to the plenum and the diffuser panel then distributes the conditioned air through holes to the base of the chamber. The air pressure in the chamber may be maintained above atmospheric pressure to reduce the reduce of external contaminants from entering the chamber.

The diffuser panel may be constructed from any material that will meet the structural requirements of the chamber and the method of holding the roots of the cultivar, such as metal, wood, plastic or a composite. The panel may be required to be waterproof. The panel maybe required to support a load in the form of potted plants, hydroponic tubes or troughs or other growing method. The thickness of the panel will be determined by the chamber specifications or by the material chosen. The diffuser panel may be mounted on support brackets on walls of the chamber or by using standoffs and bolts to support larger panels from the floor.

The diffuser panel may be shaped or formed into a shape that provide rigidity or strength or resistance to bending or other parameters determined by the specifications for the chamber.

The diffuser panel may be perforated with multiple holes or slots or other shaped cut outs. The number of holes or slots, the size or dimensions of the holes or slots and the spacing of the holes or slots may be determined by the size and spacing of the cultivar being grown. For example, a system using six-inch common plant pots may require holes or slots based on a six-inch grid; eight-inch pots may have holes on an eight-inch grid. The holes may be placed on each side of where each pot or trough or tube or other method of providing support for the plant and its roots, is located, in a grid such that there is air flow on all sides of the plant. The diffuser panel may be replaceable so that it can be removed and replaced with a different diffuser panel if different cultivars are to be grown in the chamber or a different grow arrangement is to be used, such as replacing pots with trays, or hydroponic equipment.

The size of the holes or slots is determined by the air flow requirements and the pressure specification for the system. The size is then determined by dividing the total area of air intake by the number of holes required which then yields the size for each hole in the panel

This movement of the air may reduce the amount of dead air, or air that is not moving around the plants. Air that is not moving may increase the likelihood of mold, reduce the ability of the plant to photosynthesize, exchange CO₂ and O₂, and cause other problems. The air passing the leaves of the cultivar may cause movement of the cultivar strengthening the plant and reducing the need for plant supports. The movement of air may also reduce the build-up of humidity and O₂ near the plant foliage.

The volume of the air space in the chamber is generally proportional to the size of the chamber. In some embodiments, the chamber may be divided into multiple separate compartments to provide more consistent parameters across the chamber or to create multiple light recipes. The single or multiple compartments may be supplied with conditioned air from single or multiple fans or single or multiple blowers or other low-pressure compressor. The air space may be supplied with air by one or multiple input ports or by one or multiple pipes or by one or multiple ducts or other type of air handling system.

Airflow, air speed and air volume may be determined by the level of dehumidification and the temperature level required for the specific cultivar.

Air may exit the chamber through one or more air exit ports 40. The air exit port is preferably near the ceiling 44 of the chamber 10 above the level of the leaves of the cultivar. The air may pass by one or more lighting elements 45 prior to the exit port 40. The air may pass by the one or more lighting elements and absorb excess heat generated by the lighting elements. The air may pass through an exit channel 42 in the top of the chamber 10 before exiting the chamber 10.

The chambers 10 may be generally sealed, other than for the input and output ports, to reduce the risk of contamination of the chamber. The edges of walls, ceiling and floor, or the joints of the panels may be sealed for various reasons such as temperature control, humidity control, carbon dioxide and oxygen control, prevention of air, water or pest penetration, prevention of odour, pathogen safety control. Chambers can also be hermetically sealed, set for low air particle count. The chamber may be self-contained and interchangeable so that in the event of damage, broken components or contamination, a single chamber can be removed and replaced within a larger row or array. By allowing individual chambers to be replaced, the risk of entire crop loss is reduced and downtime for the growth of cultivars is also reduced.

### Lighting Elements

Lighting elements 45 may provide light inside the chamber that is received by the cultivars. The interior of the chamber, particularly the interior of the side walls 50 of the chamber 10 may be reflective, such that light emitted by the lighting elements 45 that impinge the side walls, is reflected toward the cultivar. The walls may use polished vapour deposited aluminum, which typically have a reflectivity of 95%. In this way, most or preferably, all of the light emitted by the lighting elements may be absorbed by the cultivars. Such reflectivity can increase the efficiency of the chamber.

The lighting elements 45 may preferably be LEDs or other light emitting elements. The lighting elements are preferably controllable so that the intensity and frequency or spectrum of the emissions can be controlled. The lighting elements may be controlled by a lighting control unit 47 in the chamber that can turn the lights on and off, adjust the intensity and frequency. The lighting elements preferably emit little heat, so that the lighting elements have less effect on the temperature of the chamber or the cultivars, particularly when the cultivars have grown and are in proximity of the lighting elements 45. The spectrum is preferably controllable so that a blend of wavelengths appropriate for the cultivar and stage of growth of the cultivar can be emitted.

The frequency of the light may affect gene expression of the plants, which may affect plant growth, plant taste or other properties of the plant.

Preferably, the lighting elements can generate light with a frequency of between 285 to 950 nm with narrow band control of intensity within 0.001%. The intensity of the lighting elements can preferably be controlled across all supported frequencies, both quickly (i.e. responds quickly to control signals) and across the 24-hour day.

The lighting elements may be mounted on a panel 55, such as a printed-circuit-board (PCB), or a combination of a PCB and a conductive panel. The panel may also support any drivers for the lighting elements. The conductive panel may be made of metal, such as aluminum. The panel may have a plurality of holes 57 through the panel proximate to the lighting elements. The panel may additionally include fins or other components to increase the surface area, such that the panel acts as a heat-sink to remove heat from the lighting elements and any drivers. Air from the chamber may pass through the perforation holes 57 and pass next to the panel. Preferably the panel, with the mounted lighting elements and drivers is thin, preferably less than ¼ of an inch. The holes are preferably sized to allow laminar flow of air through the holes. Heat from the lighting elements and panel may transfer to the air, cooling the lighting elements and panel. The air may then pass through the exit channel 42 and exit port 40. The air may then be emitted to the external environment, or be recirculated after being reprocessed, such as by cooling or heating the air and adjusting the oxygen and carbon dioxide, as described elsewhere. Particulate and odour may also be processed or removed if the air is recirculated.

The circulation of the air to cool the lighting elements and the use of LEDs may allow the lighting elements to operate a cool temperature, such as 44 C or cooler. A cooler operating temperature for the lighting elements allows the cultivars to be grown closer to the lighting elements. This allows a smaller chamber to be used for a given size plants, or alternatively, larger plants to be grown in a given size chamber. A lower operating temperature may increase the operating life of the components, particularly the lighting elements.

### Control Systems

Control systems, either associated with an individual chamber, or with a plurality of chambers, may control the composition (such as oxygen and carbon dioxide concentrations) of the atmosphere in the chamber, the airflow, the light spectrum and light cycles, and the temperature and humidity of the atmosphere in the chamber, and the nutrients supplied to the cultivars. The control systems may comprise the air monitoring and control unit, nutrients monitoring and control system 27 and lighting control unit referred to above. The control system may control each of these parameters in real-time or near real-time in each of the chambers.

The control systems may be located within or associated with each of the chambers. Alternatively, or in addition, a plurality of chambers, such as a row or array may be controlled by a control system. In either case, a control communications system may allow communication between the control system of each chamber or group of chambers, and a central controller. The control system may be wired, wireless or a combination to allow two-way communication between the sensors of chambers, the control systems for a chamber or group of chambers and a central controller. The communication system may be decentralized. One or more of the chambers or central controllers may be remote. The central controller, or one or more of the controllers may be cloud based.

The controller may allow monitoring and reporting on each array, row, chamber and plant. For example, the controller may indicate which chamber is to be harvested next based on the number of days since planting or cloning. The controller may track the timing of the planting or cloning of new cultivars so that the chamber is ready to be harvested at the appropriate time for a delivery or to avoid scheduling workers on a holiday.

In addition to controlling chambers, the central controller may additionally control aspects of the facility such as physical access, security, HVAC, electrical, emergencies, remote notifications or other aspects of the facility.

The controllers may collect and store the sensor values from each of the sensors associated with each chamber. This may include temperature, humidity, CO2 and oxygen levels, light emissions, nutrimental data, water consumption, grow medium conditions (pH, temperature, oxygen, TDS and EC levels) and plant weight. For each chamber, multiple sensors may be used for redundancy and to measure values at different locations within the chamber. Still images or video may be captured from cameras in a chamber in visible and/or non-visible light. Image acquisition may be coordinated with the lighting system so that images may be captured while different spectrum of light is emitted which may allow for the viewing of different kinds of growth features in a variety of spectra using a single-filtered camera. The images or video may be stored for later monitoring or used by the control system to detect abnormal growth requiring inspection or modification to the recipe, such as by monitoring the color of the plants.

The chambers may be controlled to follow a set of defined instructions, a recipe, to facilitate the growth of the cultivar. The recipe may include temperature, atmospheric conditions, nutrient levels, and lighting characteristics that may vary over time. The recipe may be facilitated by the control systems described above to regulate the inputs and outputs from the chamber to achieve the characteristics of the recipe.

The control system may follow a recipe in a reproducible manner so that multiple chambers have the same characteristics, either simultaneously, consecutively or some combination. In this way, the results of the growth of the cultivar is preferably reproducible and standardized. Predictable yields from cultivars are desirable, including for the cannabis industry. Predictable yields and grow times can lead to efficiencies because of more predictable production capacity and therefore more predictable delivery schedules and quantities. Variations in plant chemical profiles may affect product quality and labeling. For example, with cannabis plants, weight, the percentage of compounds, such as THC and CBD, smell (terpenes) and taste (flavonoids) are properties that it is desirable to be kept consistent across multiple plants and multiple harvests. For other cultivars, the properties may be size, crispness of the leaves, taste, volume, and percentage of essential oils.

Different recipes may be applied to a chamber depending on the desired growth characteristics of the cultivar, different cultivar (such as different variants or species) or to do experiments on the growth patterns under different conditions.

A recipe may be initiated with placing cultivars in a chamber. The cultivars may comprise seeds, small plants or clones. The recipe may include initial CO₂, humidity, temperature, light and nutrients for the cultivars.

The growth cycles of individual chambers and within arrays may be staggered so that cultivars are ready to harvest at different times, reducing the overall capacity needed for harvesting. The chambers may also be on different cycles with the lighting elements having different on/off cycles so that electrical usage is more evenly distributed.

Recipes may be shared between operators of the system so that recipes can be reused or tested. Preferably the chambers are interchangeable and can reproduce the recipes accurately so that recipes can be easily applied to different chambers. By recording sensor values and plant characteristics, along with the control system parameters, variations to the recipe can be compared. Some recipes may be more successful than others, leading to improved cultivar growth.

For example, in a first chamber, a first temperature characteristic may be used while in a second chamber, a slightly warmer temperature characteristic may be used. If other parameters of the chambers are the same, the effect of the different temperatures may be determined during the plant growth and at harvest. Similarly, if in a first chamber a first strain is grown and in a second chamber a second strain is grown, the chambers may each execute an identical recipe, allowing a direct comparison of the growth characteristics of the two strains.

A cultivar growing system may comprise a plurality of chambers. Each chamber comprises a floor, walls and a ceiling. The chambers also support for a plurality of cultivars. The chambers also include sensors that monitor light, temperature, humidity, carbon dioxide and nutrients in the chamber and lighting elements that supply light from the direction of the ceiling of the chamber. The chamber also includes an air supply that supplies air from the direction of the floor of the chamber and a nutrient supply that provides nutrients and water to the cultivars. The chamber may also include one or more control systems for controlling the lighting elements, air supply and nutrient supply, wherein the one or more control systems incorporates information from the sensors and a predetermined growth recipe. The one or more control systems for a first chamber of the plurality of the chambers may control based on a first predetermined growth recipe and the one or more control systems for a second chamber of the plurality of the chambers controls based on a second predetermined growth recipe.

It should be understood that steps and the order of the steps in the processing described herein may be altered, modified and/or augmented and still achieve the desired outcome. Throughout the specification, terms such as “may” and “can” are used interchangeably and use of any particular term should not be construed as limiting the scope or requiring experimentation to implement the claimed subject matter or embodiments described herein. Further, the various features and adaptations described in respect of one example or embodiment in this disclosure can be used with other examples or embodiments described herein, as would be understood by the person skilled in the art.

A portion of the disclosure of this patent document contains material which is or may be subject to one or more of copyright, design patent, industrial design, or unregistered design protection. The rights holder has no objection to the reproduction of any such material as portrayed herein through facsimile reproduction of the patent document or patent disclosure, as it appears in the Patent and Trademark Office patent file or records, but otherwise reserves all rights whatsoever

1. A cultivar growing system comprising:
a plurality of chambers, each chamber comprising
a floor, walls and a ceiling;
supports for a plurality of cultivars;
sensors that monitor light, temperature, humidity, carbon dioxide and nutrients in the chamber;
lighting elements that supply light from the direction of the ceiling of the chamber;
an air supply that supplies air from the direction of the floor of the chamber;
a nutrient supply that provides nutrients and water to the cultivars;
one or more control systems for controlling the lighting elements, air supply and nutrient supply, wherein the one or more control systems incorporates information from the sensors and a predetermined growth recipe;
wherein the one or more control systems for a first chamber of the plurality of the chambers controls based on a first predetermined growth recipe and the one or more control systems for a second chamber of the plurality of the chambers controls based on a second predetermined growth recipe.

2. The cultivar growing system of claim 1 wherein the plurality of chambers comprise at least the number of chambers as there are days in the average growth cycle of the cultivar.

3. The cultivar growing system of claim 1 wherein the cultivar of the second chamber has a different expected harvest date than the first chamber.

4. The cultivar growing system of claim 1 wherein the lighting elements comprise LEDs, wherein an intensity and a spectrum of the LEDs is controlled by the one or more control systems.

5. The cultivar growing system of claim 1 wherein the an air supply comprises an air conditioning of the air comprising heating or cooling the air; and adding or removing humidity from the air.

6. The cultivar growing system of claim 5 wherein the air supply further comprises a diffuser which distributes air within the chamber by directing air upward from the direction of the floor of the chamber.

7. The cultivar growing system of claim 1 further comprising a plurality of skids, each skid being replaceable in a chamber of the plurality of chambers, each of the plurality of skids supporting the cultivars and being removable so the cultivars may be harvested.

8. The cultivar growing system of claim 7 further comprising a calibration skid, the calibration skid comprising one or more sensors for monitoring of temperature, light, humidity, carbon dioxide and nutrients of a chamber.

9. A method of growing cultivars comprising:
initiating a first chamber with initial conditions of CO2, humidity, temperature, light and nutrients;
placing cultivars in the first chamber;
monitoring of light, temperature, humidity, carbon dioxide and nutrients in the chamber;
controlling the first chamber comprising the emission of light on the cultivars in the first chamber; the temperature, humidity and carbon dioxide of the air in the first chamber; and controlling the nutrients supplied to the cultivars in the first chamber;
initiating, monitoring, and controlling based on information from the sensors and a predetermined growth recipe.

10. The method of growing cultivars of claim 9 further comprising initiating, monitoring and controlling a plurality chambers, where in the number of chambers in the plurality chambers is at least the number of days in the average growth cycle of the cultivar.

11. The method of growing cultivars of claim 10 wherein at least a second chamber of the plurality of chambers has a different expected harvest date than the first chamber.

12. The method of growing cultivars of claim 9 wherein the controlling the first chamber comprising the emission of light on the cultivars comprises controlling an intensity and a spectrum of LEDs.
